(19) United States
(12) Patent Application Publication
(10) Pub. No.: US 2002/0168250 A1
(43) Pub. Date: Nov. 14, 2002

(54) Method and apparatus for forming a binder cover and ring binder

(76) Inventor: Stephen R. Welch, Roselle, IL (US)

Correspondence Address: Jack Shore, Haman & Benn, 10 South LaSalle Street, Suite 3300, Chicago, IL, 60603, US

(21) Appl. No.: 09/852,996

(22) Filed: May 10, 2001

(51) Int. Cl. B42C 13/00

(52) U.S. Cl. 412/22

(57) ABSTRACT

The present invention includes a method of forming a ring binder. In the first step, creases are formed transversely across the binder board such that the creases define a spine area that partitions a defined front and back area. Next, a pair of holes is formed on the binder board sufficiently spaced apart to align with apertures on the ring mechanism. The ring mechanism may now be attached to the binder board either with a pair of removable rivets or normal rivets. Finally, the binder board is bent along the creases to form the ring binder. In alternate embodiments various number and positions of the creases are used to form different styles such as a flat back, round back, diamond back and 4 crease back.

### FIELD OF THE INVENTION

This invention relates generally to machines used to form binder covers and ring binders, and more particularly to, portable ring binder machines for forming creases in a binder board such that the binder board may bend about the creases to form a cover and machines for forming holes in the binder board such that a ring mechanism may be attached to the binder board to form a ring binder. This invention further includes a method for forming the ring binder from the binder board.

### BACKGROUND OF THE INVENTION

In today's marketplace the desire to personalize products has spawned the need to develop the products in such a way that personalization may be added at the consumer level. Such products are manufactured as generic as possible with added options of personalization. In virtually every business this has caused the retail stores to carry numerous “add-on” items, with the hopefulness that the consumer will personalize the item in some fashion. However, if the consumer cannot personalize the product, the manufacturer must produce multiple variations in an attempt to provide the consumer with at least a selection. The retailer must then showcase all of the variations, which may dramatically increase the size of the retailer's store. One such product in particular is a ring binder.

While in the simplest terms a ring binder is formed by fixing a ring mechanism to a cover, the manufacturing aspect is extremely cumbersome. Multiple colors, sizes, designs, and even shapes have required manufacturers to develop multiple types and die sets in their binder forming machines as well as have multiple colors and designs readily available to provide different covers. Ring mechanisms also come in different shapes (O and D rings) and various sizes (½″, ¾″, 1″, 1½″, 2″, 3″, 4″ and 5″). The ring mechanisms may also be affixed to the cover in different locations (on the spine or on the back cover). In yet other variations, a typical cover may be shaped such that the binder forms a flat or substantially round back. As such, a retailer's inventory becomes extremely large when trying to provide the consumers with even a small variety of binders.

Therefore there exists a need to reduce the inventory space required to compensate for all the variations, while at the same time provide the most personalization to the consumer. In commonly owned application, U.S. application Ser. No. 09/769,723 filed Jan. 25, 2001, entitled “MODULAR RING BINDER ASSEMBLY WITH REMOVABLE RIVETS,” which is incorporated by reference herein, there is disclosed a ring binder assembly that is capable of being assembled and disassembled by the consumer such that the components are interchangeable with other similarly configured ring binders. This would allow the user to chose the color of the cover, ring mechanism and rivets, assemble the ring binder and then change the color, size or design at any time thereafter, without having to purchase an entirely new binder. As such the retailer would not be required to stock shelves upon shelves of already assembled ring binders. In commonly owned application, U.S. application Ser. No. 09/ filed entitled “METHOD FOR CREATING A SINGLE CONTINUOUS DESIGN TILED FROM MULTIPLE IMAGES AND AN ARTICLE FOR VIEWING THE SINGLE CONTINUOUS DESIGN,” which is incorporated herein by reference, there is disclosed in one embodiment a binder having a pocket across the cover. The consumer using the method disclosed therein may create a single continuous design from multiple images that may be inserted into the pocket creating a single continuous design that may be removed and changed by the consumer at any time. Since the consumer could personalize the binders as desired, the retailer would not be required to keep an inventory of design covers with all the latest sensations. However, since the binders may further include various styles (round or flat), the retailer would still be required to shelve all the various styles. In commonly owned U.S. Pat. No. 6,209,917 entitled “UNIBODY BINDER AND THE PROCESS OF MAKING THE BINDER,” and divisional application filed Dec. 8, 2000, Ser. No. 09/288,399, entitled the same, both of which are incorporated by reference herein, there is disclosed a binder using a single uncompromised board which includes the formation of knuckles or living hinges transversely across the binder board, which provide the binder with the ability to hinge or open at these knuckles. Depending upon where the knuckles are placed and the number of knuckles, additional styles of binders (such as diamond or hex back profiles as well as round and flat) may be created from one single uncompromised board. While this reduces the inventory of the manufacturers, in that the various styles may be easily formed from a single board, the retailers are still required to stock the style.

As such there still exists a need to reduce the space of inventory required to compensate with all the binder variations, while at the same time providing the most personalization to the consumer. Moreover, this need exists not only at the manufacturing level but especially at the retailer level.

### SUMMARY OF THE INVENTION

In accordance with the present invention a method and machines for forming binder covers and ring binders are described herein. In one embodiment a binder forming machine includes: an entrance and an exit portion in which a binder board may be fed therethrough, a means to form creases in the binder board, and a means to determine the appropriate position of where to form the creases. Various numbers and predetermined placement of the creases may form different styles of binder covers. In the preferred embodiment the machine is automatic and includes a numeric keypad in which the operator may enter the specific style, placement and size of the ring mechanism. Upon entering the specific information, the user begins to feed the binder board through the entrance of the automatic machine. A sensing means sensing the edge of the binder board can determine the correct distance to begin to form the creases. Automatic rollers further help to feed the board through the machine.

The machine may further be manual, requiring the user to measure the distance to place the creases. The measurements may be made using an indicator on a table portion that extends out of the exit portion of the manual machine. In the manual embodiment, the means to form creases are controlled using a pedal.

In addition thereto, the machine may cut or bore holes in the binder board, such that the holes may further align with apertures in a ring mechanism. The ring mechanism may further be attached to the binder board by removable rivets, disclosed in the commonly owned U.S. application Ser. No. 09/769,723 or by using typical rivets. When using removable rivets, the binder board may include multiple pairs of holes bored at various positions, such that different ring capacities or different ring shapes may be attached. In yet another embodiment of the present invention the machine may be a separate machine such that one machine forms the creases and one machine cuts or bores the holes.

The present invention further includes a method of forming a ring binder utilizing the aforementioned machine or machines. In the first step, creases are formed across a width of the binder board such that the creases define a spine area that partitions a defined front and back area. Next, a pair of holes is formed on the binder board sufficiently spaced apart to align with apertures on the ring mechanism. The ring mechanism may now be attached to the binder board either with a pair of removable rivets or normal rivets. Finally, the binder board is bent along the creases to form the ring binder. In alternate embodiments various number and positions of the creases are formed to style the binder board, into different styles such as a flat back, round back, diamond back and 4 crease back.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of an automatic binder forming machine in accordance with the present invention;

FIG. 2 is a top view of the automatic binder forming machine illustrating a partial view of the creasing means and a binder board;

FIG. 3 is side view through the automatic binder forming machine;

FIG. 4 is a top view of the automatic binder forming machine;

FIG. 5 illustrates various styles of binders that can be formed by forming various creases in a binder board using the machine described by the present invention;

FIG. 6 is a perspective view of a manual binder forming machine in accordance with the present invention;

FIG. 7 is a top view of the manual binder forming machine illustrating a partial view of the creasing means and binder board and illustrating the table portion with various markings to indicate the positions of where to form a crease;

FIG. 8 is a perspective view of a hole forming machine to punch or bore holes in a binder board for alignment with a ring mechanism;

FIG. 9a is a perspective view of the hole forming machine with a binder board inserted therethrough;

FIG. 9b is a perspective view of the binder board with a pair of holes formed therethrough; and

FIG. 10 is a top view of a binder board with a plurality of pairs of holes formed therethrough for alignment with different capacity ring mechanisms.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

As mentioned above, there exists a need to reduce inventory space required to provide the consumer with numerous binder variations, while at the same time providing the most personalization to the consumer. This need exists not only at the manufacturing level but especially at the retailer level. One aspect of the present invention is to bring a portion of the manufacturing process to the retail level. While it may be conceivable to equip the retailer with machines necessary to manufacture the binders on the spot and on a need basis, such is impractical. The typical manufacturing process requires extremely large and costly machines, which may cause injury to someone not fully educated on the correct manner of its operation. In a typical binder manufacturing process, different machines may be employed to manufacture the cover, which may or may not require a separate machine for welding the hinges, as well as a machine to rivet the ring mechanism to a cover. Moreover, typical binders require different spine sizes to accommodate for various capacity or shape ring mechanisms, which requires the machines to handle different type sets that must be changed for each different capacity or shape ring mechanism.

As stated above, the present invention provides a means for the retailer to form a binder cover from a binder board and easily affix a ring mechanism thereto to form a ring binder. It should further be noted, that the present invention may be used at any level, such as a manufacturer, retailer or consumer (including any office, home or personal use). However, when used by a retailer, the retailer may form various styles of binders on a need basis, thereby reducing inventory from bulky pre-assembled binders to flat binder boards, which may be formed, personalized and assembled at the retailer for any individual consumer. The present invention is furthermore small and portable allowing the retailer or consumer to form binder covers without the need of bulky, cumbersome, or expensive machines.

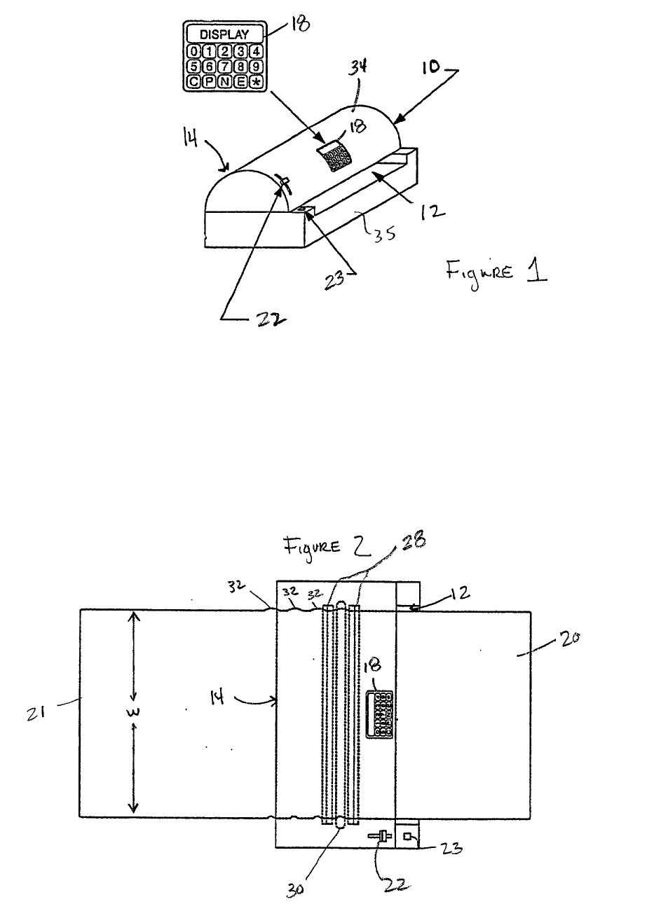

In the first embodiment of the present invention, illustrated in FIG. 1, a binder cover forming machine is illustrated and generally referenced to number 10. The binder cover forming machine 10 displaces a section of material to form living hinges that function like a “joint” or knuckle. The machine 10 forms the living hinges by forming creases or knuckles transversely across the width “w” of the binder board 20, such that the binder board may bend about the creases to form a binder cover. The binder cover when bent will have a specific style (discussed in greater detail below) that is defined by the number of and/or placement of the creases. Once creased and holes are bored into the binder board, a ring mechanism may be attached thereto to create a ring binder.

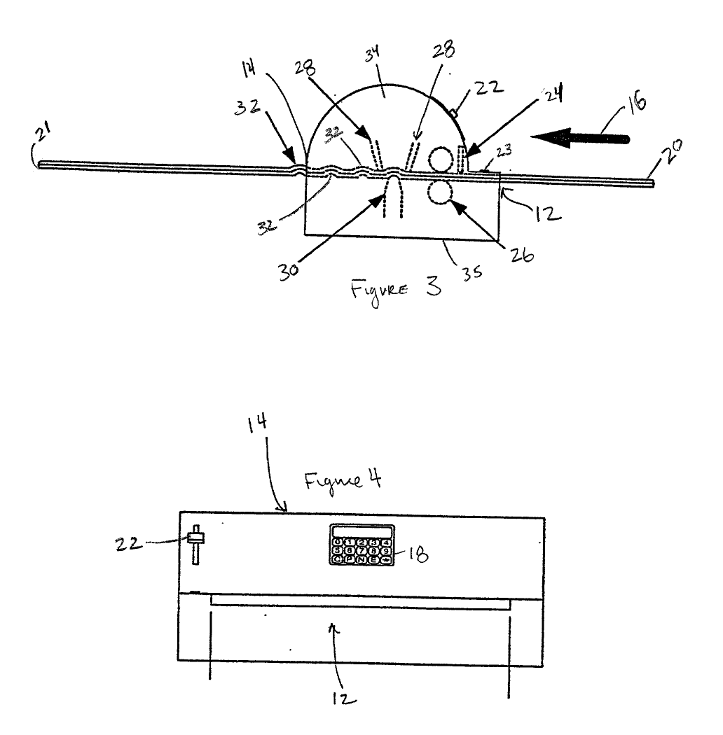

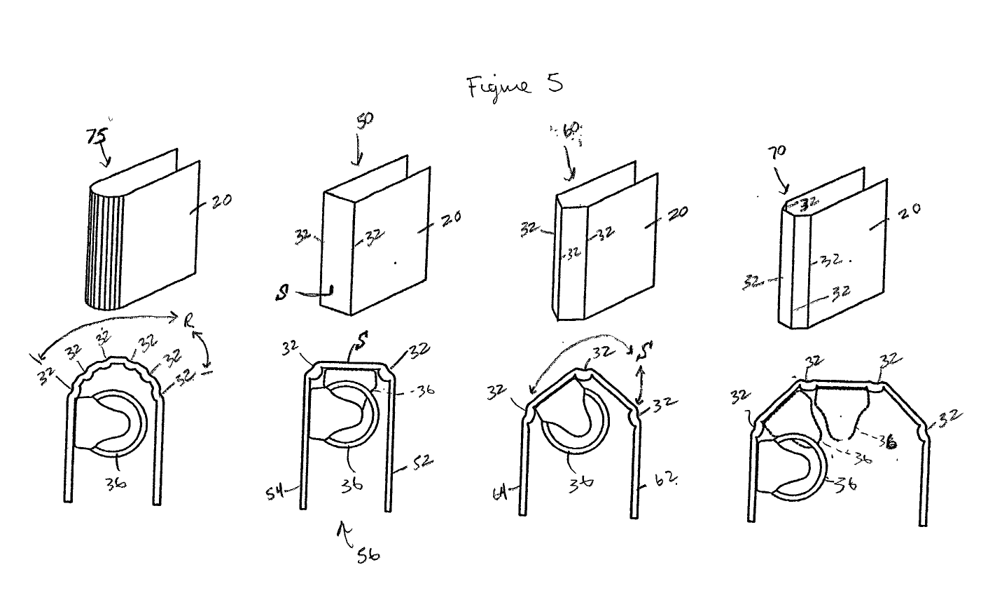

The machine 10 includes a channel (not shown) defined by an entrance portion 12 and an exit portion 14, which further define the direction in which a binder board 20 (shown in FIGS. 2 and 3) is fed through the machine, indicated by arrow 16. The entrance portion 12 is a tight feed path preventing the user to gain access to the internal mechanisms of the machine 10 while in operation. The machine 10 includes a numerical keypad and display 18 for entering information regarding the specific style of binder desired, the size, shape (O or D ring) and/or placement (spine or back cover) of the ring mechanism that will be attached to the binder board 20. In addition thereto, the machine also includes a crease force adjustment lever 22 in order to adjust the depth of the creases. While typically the machine 10 will be set for a preferred depth, the machine 10 may need to be adjusted if the binder board 20 has a stiffer or lighter consistency.

Referring now to FIG. 3, the binder board 20 having been feed through the machine 10 is now in the process of having a crease formed. In the preferred embodiment, the machine 10 automatically feeds the binder through the machine 10, forming creases transversely across the width “w” (shown in FIG. 2) and automatically at the correct distances that are defined by the information previously entered in on the numeric keypad 18. The machine determines or computes the distance to begin the first crease by sensing the front edge 21 of the binder board 20 as it is first fed through the machine 10. This is accomplished by incorporating a sensing means 24 positioned above the entrance 12 and adjacent to a pair of motor driven feed rollers 26 (“rollers), which automatically feed the binder through the machine 10. The pair of rollers 26 is separately positioned above and below the channel. The sensing means 24 sensing the front edge 21 of the binder board 20 transmits the same to various electronics or an on-board computer (not shown) to determine when to begin forming the creases. The electronics also controlling the rotation of the rollers 26 determines how far the binder board 20 has been automatically fed through the machine 10 and stops and starts the rollers 26 in order to form creases and to move the binder board 20 to the next position.

The means to form creases in the binder board 20 is accomplished by reciprocating elongated blades defined by a pair of upper nibs 28 and a lower blade 30 positioned about the channel of the machine 10. The upper nibs 28 and lower blade 30 extend transversely across the full width “w” of the binder board 20, illustrated in FIG. 2. When the binder board 20 reaches its prescribed position between the upper nibs 28 and the lower blade 30, the upper nibs 28 and the lower blades 30 move inwardly towards each other to displace the portion of the binder board 20 to form a crease 32 (or hinge). The blades are then automatically retracted and the rollers 26 move the binder 20 a predetermined amount such that additional creases if needed may be formed.

Upon completion of forming the creases 32, the rollers 26 may continue to rotate, moving the binder board 10 out of the exit portion 16. When the entire binder board 20 has passed through the entrance portion 14, the sensing means 24 may indicate to the computer to stop the rollers 26, wherein the operator may pull the binder board 20 out of the machine 10, or the rollers 26 may continue to rotate for a predetermined amount of time, such that the binder board 20 has been automatically fed through the machine 10.

In addition thereto, the embodiments disclosed herein above and below may include an on/off switch 23. Moreover, the top portion 34 of the machine 10 may be removably or hingedly attached to the bottom portion 35, such that the internal mechanisms of the machine 10 may be accessed, for purposes of maintenance. As such, internal safety switches (not shown) may automatically turn the machine off, when the top portion of the machine is opened.

The binder board 20 having creases 32 formed therein may bend at such creases to form a binder cover. Referring now to FIG. 5, the binder board 20 may be creased and formed into various styles, such as a flat back 50, a diamond back 60, a four crease back 70, and a round back 75. In a flat back 50, the binder board includes two creases 32 spaced apart by a predetermined distance to form a spine area S between the creases 32, as well as to form a front 52 and back portion 54. A ring mechanism 36 may further be attached to either the spine area S or the back portion 54, thereby forming a ring binder 56. In the diamond back 60, the binder board includes three creases 32 evenly spaced about the center portion of the binder board. The spine area S defined by between the two outermost creases 32 separates the binder board 20 into a front portion 62 and a back portion 64. Moreover, the ring mechanism 36 may be attached to the spine area S, between two of the three creases 32, as illustrated. In the four crease back 70, the binder board 20 includes four creases 32, which separate a front and back portion, wherein the ring mechanism 36 may be attached to various areas, as illustrated. The binder board 20 may also include a plurality of creases 32 closely spaced apart about the center portion of the binder board 20 forming a rounded spine area R shown in a substantially round back 75, which is defined between a front and back portion.

Moreover, it is preferable that the binder forming machine 10 is used with binder boards manufactured under Applicant's commonly owned U.S. Pat. No. 6,209,917 entitled “UNIBODY BINDER AND THE PROCESS OF MAKING THE BINDER” and divisional application filed Dec. 8, 2000, Ser. No. 09/288,399, entitled the same. However, it is fully contemplated by the present invention that typical binder boards may be used. In the preferred embodiment, the binder boards also have the same overall length regardless of the desired style or size of the ring mechanism to be used therewith. As such, the inventory may consist of binder boards having the same overall uniform length. However, it is fully contemplated by the present invention that different length binder boards may be employed. Under such instances, the overall length of the binder board may be entered through the numerical keypad 18, such that the computer may accurately determine the proper placement of the creases 32.

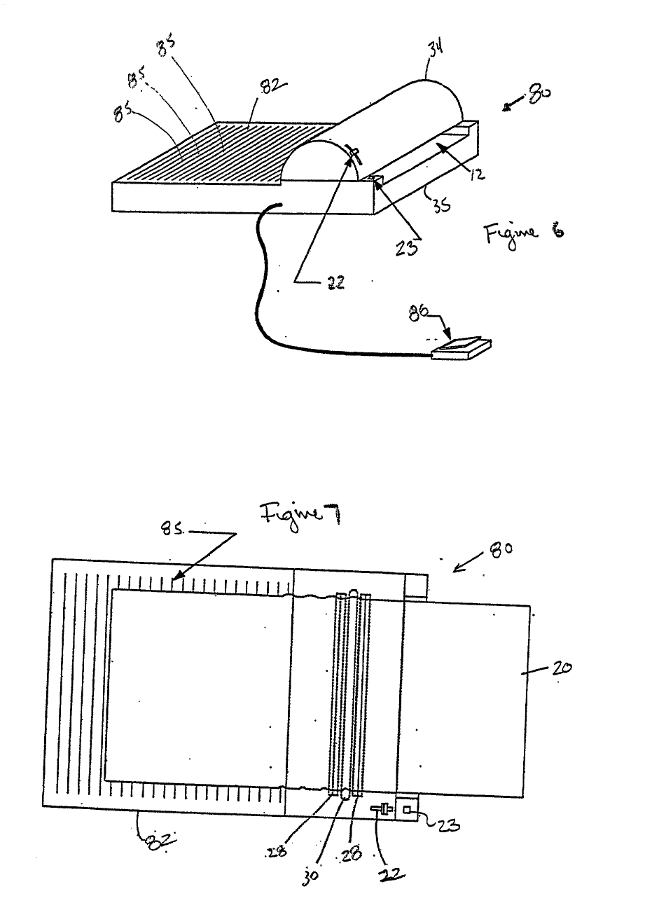

In a subsequent embodiment of the present invention, the binder forming machine 10 may form creases 32 manually rather than automatically. Referring now to FIG. 6, a manual binder forming machine 80 is illustrated. The manual binder forming machine 80 includes a table portion 82 extending along the exit portion 84 of the machine 80. The table portion 82 further includes markings or indentations 85 to indicate the correct position of the binder board 20, such that the operator may determine when a crease should be formed. The creasing means, which is described above, is controlled by a pedal 86, such that when the operator pushes the pedal 86 (or other external switch) the creasing means will form a crease in the binder board 20.

In another embodiment the automatic crease forming machine may include a manual override to allow a user to add additional creases in the binder for aesthetic purposes. In such instances the automatic machine may include a pedal to manually activate the creasing means.

In addition, the binder forming machines disclosed herein may also include means to form holes in the binder board 20. Upon completion, the holes will properly align with holes or eyelets on a ring mechanism in order to receive a pair of rivets such that the ring mechanism may be attached to the binder board 20. In an automatic binder forming machine, the hole forming means may be activated automatically dependent upon variables entered on the numeric keypad, such as the style, the ring capacity size and the placement. In a manual binder forming machine, the hole forming means may be activated by an external switch, wherein the placement of the holes is to be aligned by the operator. While typical rivets may be used, requiring the operator to utilize a riveting machine, the rivets may further be of a type disclosed in Applicant's commonly owned U.S. application, Ser. No. 09/769,723 filed Jan. 25, 2001, entitled “MODULAR RING BINDER ASSEMBLY WITH REMOVABLE RIVETS.”

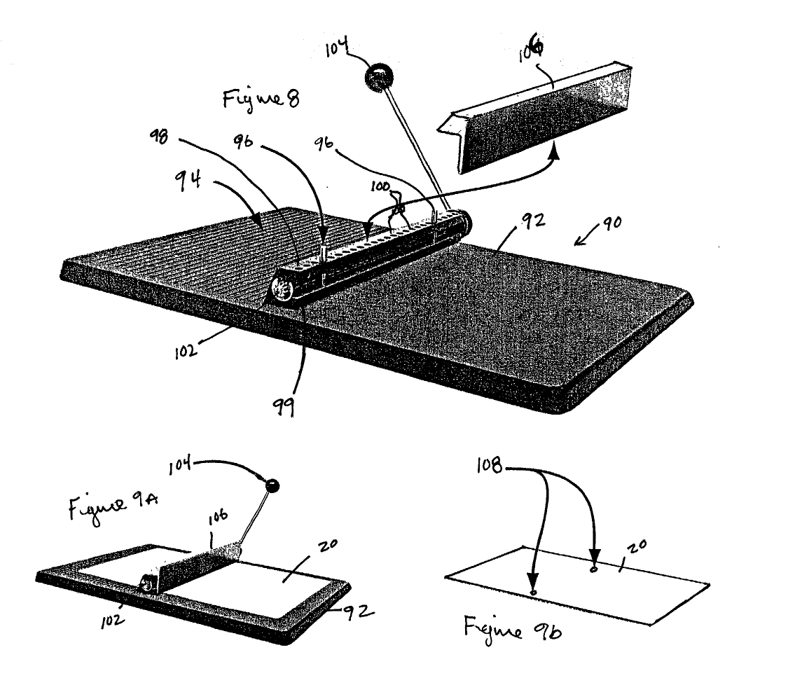

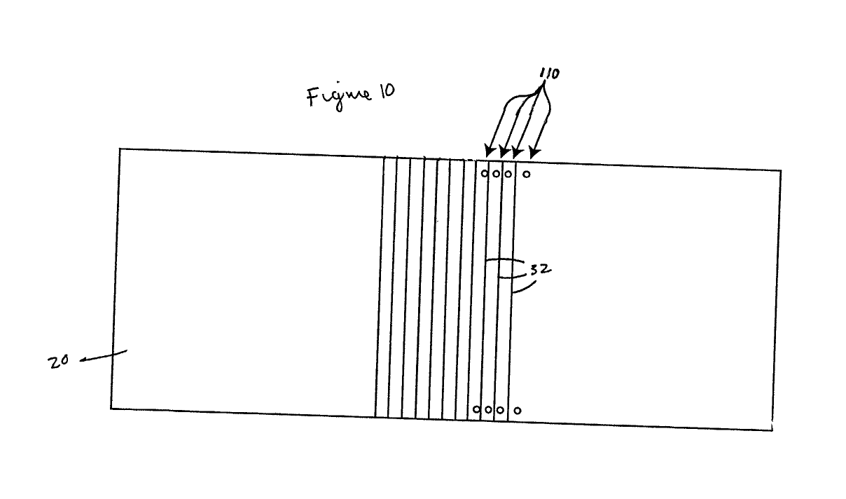

The hole forming means may also be a separate machine, such as the hole forming machine illustrated in FIGS. 8 through 9b. A hole forming machine 90 is shown and includes a substantially flat bed 92 such that a binder board 20 may lie thereon. Preferably the binder board 20 already has the creases 32 formed thereon, however, the holes may further be created prior to forming the creases if so desired. The bed 92 further includes a grid 94 that indicates the distance to place the binder board 20 such that the holes formed in the binder board will properly align with a specific capacity ring mechanism such that the binder board 20 may properly form a binder cover.

The hole forming machine 90 further includes the means to bore, cut or form the holes in the binder board 20. The hole forming means is defined by a pair of dowels 96 that are set and spaced apart in a dowel holder 98 that runs across the width of the bed 92. The dowel holder 98 includes a plurality of slots 100 such that the dowels 96 may be adjustable, setting a specific distance in between the pair of dowels 96 to correspond to distance between apertures or eyelets on the ring mechanism. In certain instances where the length of the ring mechanism changes the user may be required to reset the distance between the pair of dowels 96. The dowel holder 98 also includes an opened area 99 defined along its bottom portion such that a clearance is defined between the dowel holder 98 and the flat bed 92. The clearance moreover, is sized to receive the binder board 20.

Each dowel 96 includes teeth (not shown) that engage other teeth (not shown) on a horizontal rack 102 that is contained within the dowel holder 98. The rack 102 is further connected to a lever 104. When the lever 104 is pushed down, the rack 102 rotates causing the dowels to translationally move downward. Moreover, the dowels also include a substantially sharp bottom edge such that, if a binder board 20 is placed under the dowels 96 and the dowels 96 are moved downwardly with sufficient force, the dowels 96 will bore or cut a pair of holes 108 in the binder board 20. In addition thereto, the hole forming machine 90 may also include a removable cover 106 that is placed over the dowel holder 98 to help prevent injury.

Once the user forms holes in the binder board 20, removable rivets, such as which is disclosed in Applicant's commonly owed U.S. application, Ser. No. 09/769,723, may be used in conjunction with a ring mechanism to complete the process of forming a ring binder. In addition thereto, the user may form multiple pairs of holes 110 at different positions about the various creases 32 on the binder board 20, illustrated in FIG. 10, such that the user may remove the rivets and replace the ring mechanism with a ring mechanism with a larger or smaller capacity, or in order to place the ring mechanism in a different position, such as from the spine to the back cover, as discussed herein above. Moreover, when using removable rivets, the binder board may be reused continuously for different ring capacity sizes and ring shapes. This will further reduce the inventory of the retailer and will also help reduce landfill space.

In addition thereto the hole forming machine may be a separate automatic machine that forms the holes in the binder board and attaches a ring mechanism to the binder board. In such an instance the ring mechanism may be affixed to the binder board by permanent rivets, well known in the art, or by removable rivets.

From the above machine or machines a method of forming a ring binder may be extrapolated, and such method preferably includes the following steps. First, at least two creases 32 are formed transversely across the width “w” of the binder board 20. The creases 32 partition the binder board 20 into at least a spine area and a front and back area. The spine area being further defined as the area intermediate to the front and back area. After the creases 32 are formed, a pair of holes 108 is bored, cut or formed into the binder board. Individually, the holes 108 are sufficiently spaced apart, such that the apertures defined on a ring mechanism (not shown) may be aligned with them. Next, the ring mechanism is attached to the binder board 20.

The ring mechanism may either be attached using removable rivets, such as those disclosed in commonly owned U.S. application Ser. No. 09/769,723 or using permanent rivets, well known in the art. Finally, the binder board is bent along the creases to form the ring binder.

In another embodiment of the method, the number and positions of the crease may change such that the previously disclosed styles (flat, round, diamond and 4 crease back) may be formed. Also, these positions may be computed or determined, such when utilizing the automatic crease forming machine 10 disclosed herein above. In yet another embodiment of the method, the binder board may be the uncompromised binder board disclosed in commonly owned U.S. Pat. No. 6,209,917 and divisional application filed Dec. 8, 2000, Ser. No. 09/288,399, entitled the same. In accordance with such an embodiment, the present invention will insure the uncompromised binder board 20 maintains maximum strength. Since the creases 32 are formed by displacing material and not removing or cutting material, the creases 32 will have a thickness throughout that is substantially that of the uncompromised binder board itself 20. By maintaining this uniform thickness the spine portion of the binder formed by the living hinges are over 500% stronger than that of the prior art arrangements.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

1. An automatic portable creasing machine comprising:
an entrance portion for receiving a binder board;
a means for sensing a front edge defined in the binder board, the sensing means positioned about the entrance portion;
a pair of motor driven rollers positioned about the entrance portion to engage and feed a binder board through the machine;
a means for forming creases in the binder board at positions such that the binder board may bend at said creases to form a binder cover;
a means for automatically determining the positions to form said creases in the binder board, the automatic determining means receives a signal from the sensing means to indicate a front edge of a binder board being fed through the entrance portion, the automatic determining means upon receiving the signal controls the motor driven rollers to move the binder board to said positions and controls the crease forming means to create a crease in the binder board at said positions.

2. The machine of claim 1, wherein the positions to form creases in said binder board is based at least upon one of the following: a style of the binder cover, a ring mechanism capacity size, placement of a ring mechanism on the binder cover, and shape of the ring mechanism.

3. The machine of claim 2 further comprising:
a means for entering information regarding the style of the binder cover, the ring mechanism capacity size, the placement of the ring mechanism on the binder cover, and the shape of the ring mechanism, said entering means is in communication with the determining means such that the determining means determines said positions to form said creases in said binder board from said information entered on the entering means.

4. The machine of claim 1 further comprising means to form rivet holes in the binder cover.

5. The machine of claim 1, wherein the creasing means includes a pair of upper nibs and a lower blade oppositely disposed and which move inwardly towards each other such that the lower blade intersects between the pair of upper nibs, wherein when a binder board is positioned between said upper nibs and said lower blade and said upper nibs and said lower blades move inwardly towards each other, a portion of said binder board is displaced to form a crease.

6. The machine of claim 1 further comprising a means for adjusting a depth of the crease.

7. A portable crease forming machine for forming creases transversely in a binder board, such that said binder board may bend at said creases to form a binder cover that is further attached to a ring mechanism to create a ring binder, the machine comprising:
entrance and exit openings for feeding a single binder board therethrough; and
means for forming creases transversely in said single binder board at predetermined positions.

8. The crease forming machine of claim 7, wherein the crease forming means includes a pair of movable upper nibs and an oppositely disposed and moveable lower blade that is positioned such that when said upper nibs and said lower blade move inwardly toward each other, the lower blade intersects the pair of upper nibs, wherein when a binder board is positioned between said upper nibs and said lower blade and said upper nibs and said lower blades move inwardly towards each other, a portion of said binder board is displaced to form a crease.

9. The crease forming machine of claim 7 further comprising:
a pair of motor driven rollers spaced about the entrance, said rollers automatically feed a binder board through said machine; and
means for controlling the motor driven rollers and the crease forming means such that said binder board being automatically fed through said machine is temporarily stopped at predetermined positions to have a crease formed at said predetermined positions.

10. The crease forming machine of claim 9 further comprising:
a means for sensing a front edge of a binder board being fed through said machine and in communication with the controlling means in order to determine when a binder board is being fed through said machine and determine said predetermined positions.

11. The crease forming machine of claim 10, wherein said predetermined positions is based upon at least one of the following: a style of binder cover, a placement of a ring mechanism on said binder cover, a ring mechanism capacity, and a shape of a ring mechanism.

12. The crease forming machine of claim 11 further comprising:
a numeric keypad and display for entering at least one of the following: a style of binder cover, a placement of a ring mechanism on said binder cover, a ring mechanism capacity, and a shape of a ring mechanism.

13. The crease forming machine of claim 7 further comprising:
a crease adjustment level for adjusting the depth of the crease formed by the crease forming means.

14. The crease forming machine of claim 7 further comprising:
an external switch for actuating the creasing means.

15. The crease forming machine of claim 7 further comprising:
a table extending outwardly from the exit portion of the machine, the table including at least two markings spaced apart that indicate a proper position to align a binder board in order to form at least two creases.

16. A machine for forming creases transversely across a binder board wherein the binder board may bend about said creases to form a binder cover for use with a ring mechanism to form a ring binder, the machine comprising:
a top portion attached to a bottom portion;
a channel having a entrance and an exit for feeding a binder board through the machine;
a pair of downwardly movable upper nibs supported above the channel and a upwardly movable lower blade supported below the channel, the upper nibs and lower blade positioned such that when moved inwardly towards each other the lower blade intersects the pair of upper nibs; and
a means for actuating the upper nibs and lower blade such that when a binder board is in said channel, the actuation of the upper nibs and lower blade forms a crease transversely across the binder board.

17. The machine of claim 16 further comprising:
a sensor positioned in the top portion of the machine and about the entrance of the channel, the sensor sends a signal indicating when a binder board is being fed through the channel;
a pair of motor driven rollers positioned above and below the channel separately to engage a binder board being fed through the channel and to automatically feed the binder board through the channel; and
an automatic determining means in communication with the sensor in order to receive signals that a binder board is being fed through the channel, the automatic determining means is further in communication with the rollers to temporarily stop the binder board at positions in which to form a crease, and the automatic determining means is further in communication with the actuating means to actuate the upper nibs and lower blade to form a crease at said positions.

18. The machine of claim 16, wherein the actuating means is a pedal.

19. The machine of claim 17 further comprising:
a means to manually activate the actuating means to form a crease in a binder board at a predetermined position that is separate from the positions automatically determined by the automatic determining means.

20. The machine of claim 17 further comprising:
a numeric keypad and display in communication with the automatic determining means, the numeric keypad and display for entering information regarding a desired shape and size of a ring mechanism and a style of binder cover, wherein the information is used by the automatic determining means for determining the positions in which to form creases in a binder board.

21. A method of forming a ring binder comprising:
forming at least two creases transversely across a binder board such that the creases partition the binder board into at least a spine area and a front and back area, wherein the spine area is defined intermediate of the front and back area;
forming a pair of holes in the binder board sufficiently spaced apart to align with apertures on a ring mechanism;
attaching the ring mechanism to the binder board with a pair of removable rivets that align in the apertures of the ring mechanism and the holes in the binder board; and
bending the binder board along the creases to form the ring binder.

22. The method of claim 21, wherein the step of forming at least two creases, further includes:
computing from a front edge defined in the binder board proper positions to form each crease.

23. The method of claim 21, wherein the step of forming at least two creases includes forming two creases sufficiently spaced apart to define the spine area therebetween such that the step of attaching the ring mechanism to the binder board includes attaching the ring mechanism to the binder board between said creases.

24. The method of claim 21, wherein the step of forming at least two creases includes forming three creases sufficiently spaced apart to define the spine area between any two adjacent creases such that the step of attaching the ring mechanism to the binder board includes attaching the ring mechanism to the binder board between any two adjacent creases.

25. The method of claim 21, wherein the step of forming at least two creases includes forming a plurality of creases in proximity to each other to define the spine area such that the step of attaching the ring mechanism to the binder board includes attaching the ring mechanism to a back area of the binder board.

26. The method of claim 21, wherein:
the step of forming at least two creases includes forming a plurality of creases in proximity to each other to define the spine area,
the step of forming a pair of holes in the binder board includes forming at least two pairs of holes adjacent to at least two different creases, and
the step of attaching the ring mechanism to the binder board includes attaching the ring mechanism to the binder board by aligning apertures in said ring mechanism with one of the pairs of holes in the binder board and attaching said ring mechanism to said binder board with a pair of removable rivets,
whereby said ring mechanism may be removed and replaced with a second ring mechanism having a different ring capacity or ring shape, and whereby the second ring mechanism may be attached to the binder board by aligning apertures in said second ring mechanism with one of the other pairs of holes in the binder board and attaching said second ring mechanism to said binder board with said pair of removable rivets.

27. A method of forming a ring binder from an uncompromised binder board, the method comprising:
forming at least two creases across the binder board such that the creases partition the binder board into at least a spine area and a front and back area, wherein the spine area is defined intermediate of the front and back area, and wherein the creases are placed in positions computed from a front edge defined in the binder board;
boring a pair of holes in the binder board sufficiently spaced apart to align with apertures on a ring mechanism;
attaching the ring mechanism to the binder board with a pair of removable rivets that align in the apertures of the ring mechanism and the holes in the binder board; and
bending the binder board along the creases to form the ring binder.

28. The method of claim 27, wherein:
the step of forming at least two creases includes forming a plurality of creases in proximity to each other to define the spine area,
the step of boring a pair of holes in the binder board includes boring at least two pairs of holes adjacent to at least two different creases, and
the step of attaching the ring mechanism to the binder board includes attaching the ring mechanism to the binder board by aligning apertures in said ring mechanism with one of the pairs of holes in the binder board and attaching said ring mechanism to said binder board with a pair of removable rivets,
whereby said ring mechanism may be removed and replaced with a second ring mechanism having a different ring capacity or ring shape, and whereby the second ring mechanism may be attached to the binder board by aligning apertures in said second ring mechanism with one of the other pairs of holes in the binder board and attaching said second ring mechanism to said binder board with said pair of removable rivets.

29. A hole forming machine for boring holes in a binder board, comprising:
a substantially flat bed having a top portion;
a dowel holder having a bottom portion and connected to the top portion the flat bed, the dowel holder includes a plurality of slots, and includes an opened area along the bottom portion such that a clearance sized to receive a binder board is defined between the top portion of the flat bed and the bottom portion of the dowel holder;
a pair of dowels that are separately received in said slots, each dowel having a plurality of teeth and have a substantially sharp bottom;
a horizontal rack contained within the dowel holder and having a plurality of teeth that engage the plurality of teeth of the dowels; and
a lever connected to the horizontal rack such that the lever when pushed downwardly, the horizontal rack rotates such that the dowels similarly move downwardly,
whereby when a binder board is positioned within the clearance and the lever is pushed downwardly a pair of holes is bored by the dowels into the binder board.

30. The hole forming machine of claim 29 further comprising a removable dowel cover.

31. The hole forming machine of claim 29 wherein the flat bed includes a grid to align an edge defined in the binder board such that a proper placement of the holes may be predetermined.
